(19) United States
(12) Patent Application Publication
(10) Pub. No.: US 2009/0151171 A1
(43) Pub. Date: Jun. 18, 2009

(54) Cardboard Cutter

(76) Inventor: Tsai-Lian Chen LIN, Huatan Township (TW)

Correspondence Address: Dr. BANGER SHIA, 102 Lindencrest Ct., Sugar Land, TX, 77479-5201, US

(21) Appl. No.: 11/955,341

(22) Filed: Dec. 12, 2007

(51) Int. Cl. B26B 1/00; B26B 27/00; B26B 3/08

(52) U.S. Cl. 30/275.4; 30/298; 30/304

(57) ABSTRACT

A cardboard cutter comprises a main body and at least one cutting assembly. The cutting assembly is slidably mounted on the main body and is fixed on the main body by a positioning assembly. By such arrangements, during cutting process, the cuffing assembly can be stably fixed on the main body by the positioning assembly and will not be moved by the upward resistance of the cardboard, so the cutting depth is fixed, and the cuffing operation can be finished at one time. Further, the cuffing lines are trim and the products are beautiful.

### BACKGROUND OF THE INVENTION

1. Field of the Invention

The present invention relates to a cardboard cutter, and more particularly to a cardboard cutter which can fix the cutting assembly stably.

2. Description of the Prior Art

In order to decorate a photograph, a cardboard cutter is usually used to cut a center portion of a thick cardboard and then the photograph is put into the cut portion of the thick cardboard, such an arrangement can not only decorate the periphery of the photograph, but also set off the photograph very well, so as to obtain a stereo sense. Referring to FIG. 1, a conventional cardboard cutter comprises a main body 10 and a cutting blade 20. The cutting blade 20 is slidably mounted on the main body 10. During cutting process, the main body 10 is placed on a cardboard A, the cutting blade 20 is moved out of the main body 10, and then the cardboard A can be cut by moving the cuffing blade 20.

However, if the cardboard A is too thick or too hard, the cutting blade 20 will bear a greater resistance during the cutting process, as shown in FIG. 2, and the cutting blade 20 may be pushed upward by the resistance of the cardboard A so that the cutting blade 20 will be returned to the main body 10. Therefore, the conventional cardboard cutter has the following disadvantages:

Firstly, since the cutting blade 20 will be returned to the main body 10 by the resistance of the cardboard A, the cuffing operation cannot be finished at one time, and the cardboard A can only be cut into a predetermined shape in two or more steps. Thereby, the cutting process of the conventional cardboard cutter is complicated.

Secondly, the cutting operation can only be finished by the cutting blade 20 in more steps, and the cutting marks are different, so the products cut by the cutting blade 20 will have many irregular cutting marks. As a result, the cutting lines will not be trim and the products cut by the cutting blade 20 are unbeautiful.

The present invention has arisen to mitigate and/or obviate the afore-described disadvantages.

### SUMMARY OF THE INVENTION

The primary objective of the present invention is to provide a cardboard cutter which can fix the cutting assembly on a main body stably, the cutting assembly will not be moved by the resistance of the cardboard during cutting process, and the cutting operation can be finished at one time. Moreover, the cutting lines are trim and the products are beautiful.

To achieve the object of the present invention, the cardboard cutter comprises a main body, at least one cutting assembly and one positioning assembly. The main body includes a pressing surface for pressing against the cardboard. The cutting assembly is slidably mounted on the main body, and an angle of the cutting direction of the cutting assembly relative to the pressing surface of the main body is larger than 0 degree. The positioning assembly is disposed on the main body and is provided for fixing the cutting assembly. By such arrangements, during cutting process, the cutting assembly can be stably fixed on the main body by the positioning assembly, so the cutting depth is fixed, and the cutting operation can be finished at one time. Further, the cutting lines are trim and the products are beautiful.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is an illustrative view showing a conventional cardboard cutter;

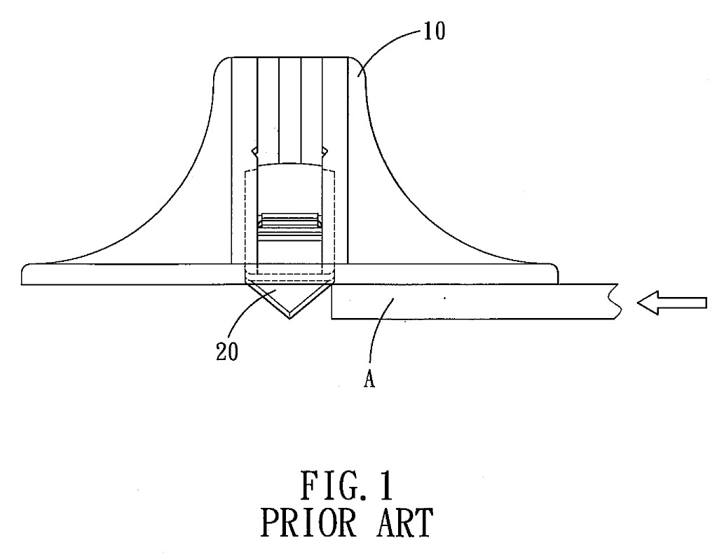

FIG. 2 is another illustrative view showing a cutting assembly moved by the resistance of the conventional cardboard cutter;

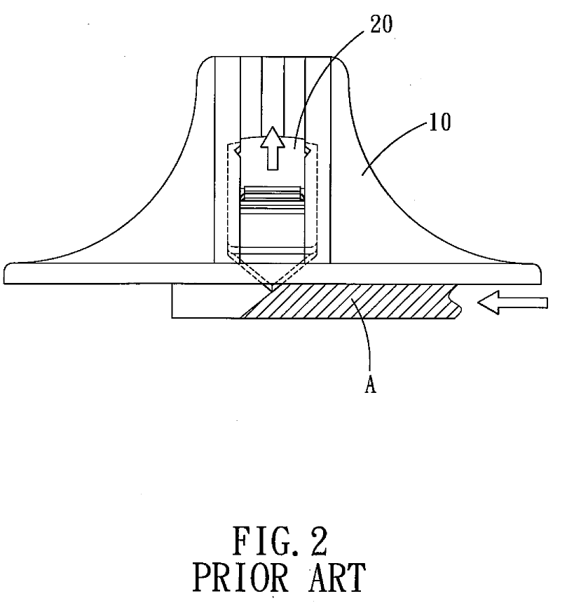

FIG. 3 is an exploded view of a cardboard cutter in accordance with the present invention;

FIG. 4 is an illustrative view showing a cutting assembly of a cardboard cutter not being fixed;

FIG. 5 is an illustrative view showing the cutting assembly being fixed;

FIG. 6 is an illustrative view showing the cardboard cutter being cooperated with tracks in accordance with the present invention;

FIG. 7 is an illustrative view showing the cardboard cutter being mounted on the tracks by a fixing member in accordance with the present invention;

FIG. 8 is an illustrative view showing the cardboard cutter cut in an arc-shaped fashion; and

FIG. 9 is an illustrative view showing a gripping member in accordance with the present invention.

### DETAILED DESCRIPTION OF THE PREFERRED EMBODIMENTS

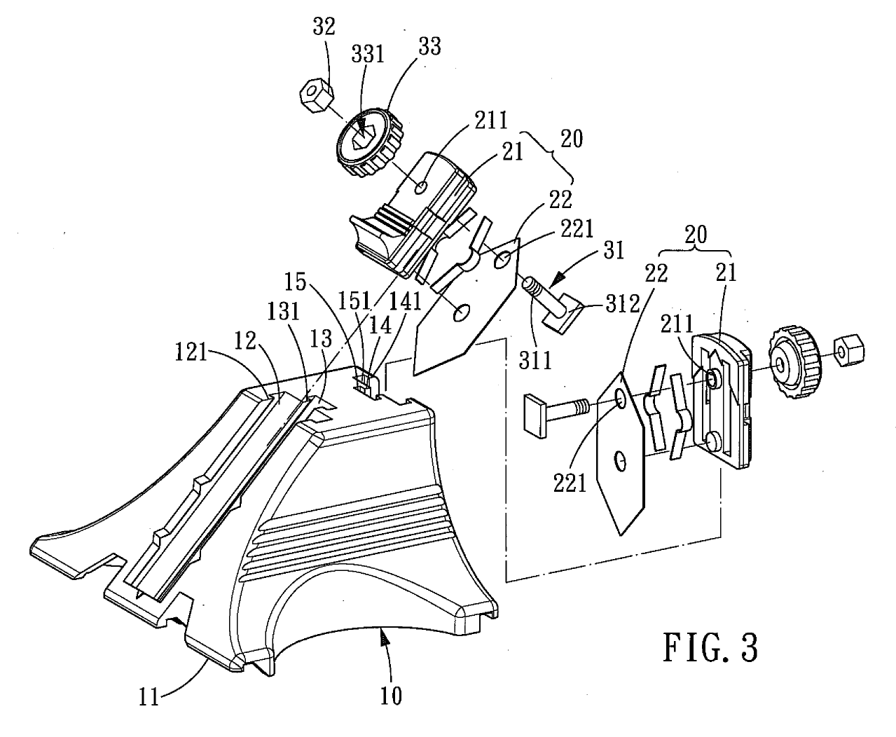

Referring to FIG. 3, a cardboard cutter in accordance with the present invention comprises a main body 10, two cutting assemblies 20 and two positioning assemblies 30.

The main body 10 includes a pressing surface 11 for pressing against the cardboard A. The main body 10 is defined with a first restricting channel 12, a second restricting channel 13, a third restricting channel 14 and a fourth restricting channel 15, and each restricting channel having a U-shaped cross section. Each of the first restricting channel 12, the second restricting channel 13, the third restricting channel 14 and the fourth restricting channel 15 is formed with two opposite restricting portions formed at two opposite outer edges thereof, respectively. The first restricting channel 12 is parallel to the second restricting channel 13, and the extension direction of the first restricting channel 12 is the same as that of the second restricting channel 13. The extension direction of the first and the second restricting channels 12 and 13 lies at an angle of 45 degrees to the pressing surface 11, respectively. The outer edges of the second restricting channel 13 are connected to the bottom of the first restricting channel 12. The third restricting channel 14 is parallel to the fourth restricting channel 15, and the extension direction of the third restricting channel 14 is the same as that of the fourth restricting channel 15. The extension direction of the third and fourth restricting channels 14 and 15 are vertical to the pressing surface 11, respectively. The outer edges of the fourth restricting channel 15 are connected to the bottom of the third restricting channel 14.

Each cutting assembly 20 includes a seat 21 and a blade 22. The seat 21 is defined with a through hole 211, the blade 22 is mounted on the seat 21 and is formed with a through hole 221 to be aligned with the through hole 211 of the seat 21. The seats 21 of the cuffing assemblies 20 are received in the first and the third restricting channels 12 and 14, respectively, such that the cutting assemblies 20 can be slidably restricted in the first and the third restricting channels 12 and 14 by the restricting portions 121 and 141, respectively. The cutting direction of the blade 22 of the cutting assembly 20 located in the first restricting channel 12 lies at an angle of 45 degrees to the pressing surface 11, and the cutting direction of the blade 22 of the cutting assembly 20 located in the third restricting channel 14 is vertical to the pressing surface 11.

Each positioning assembly 30 includes a screw 31, a nut 32 and a knob 33. One end of the screw 31 is defined with threads 311, and the other end of the screw 31 is formed with a flange 312. The knob 33 is defined with a containing recess 331 that is in the same shape as the nut 32, and in the bottom of the containing recess 331 is defined a hole 332 for engaging with the threads 311 of the screw 31. The flanges 312 of the screws 31 of the positioning assemblies 30 are slidably restricted in the second and the fourth restricting channels 13 and 15 by the second and the fourth restricting portions 131 and 151, respectively. The threads 311 of the respective screws 31 are threaded with the nuts 32 after passing through the through holes 221 and 211 of the blade 22 and the seat 21, and the hole 332 of the knob 33, respectively. And the nuts 32 are received in the containing recesses 331 of the knobs 33.

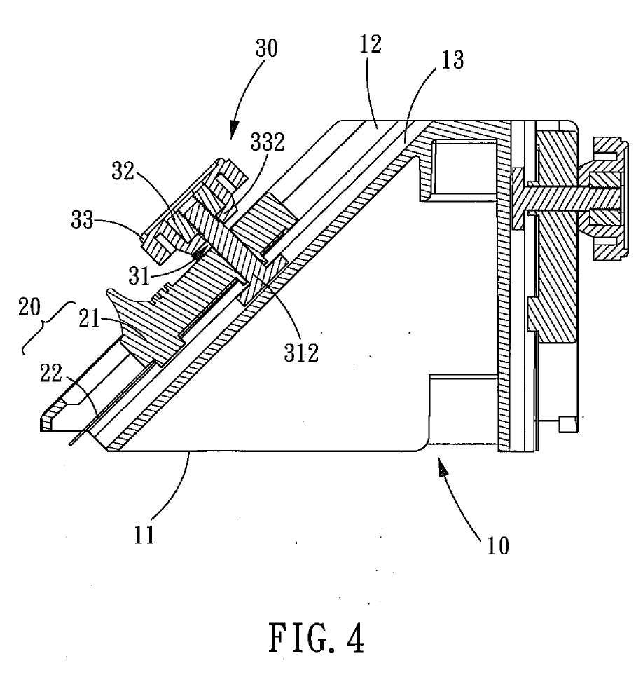

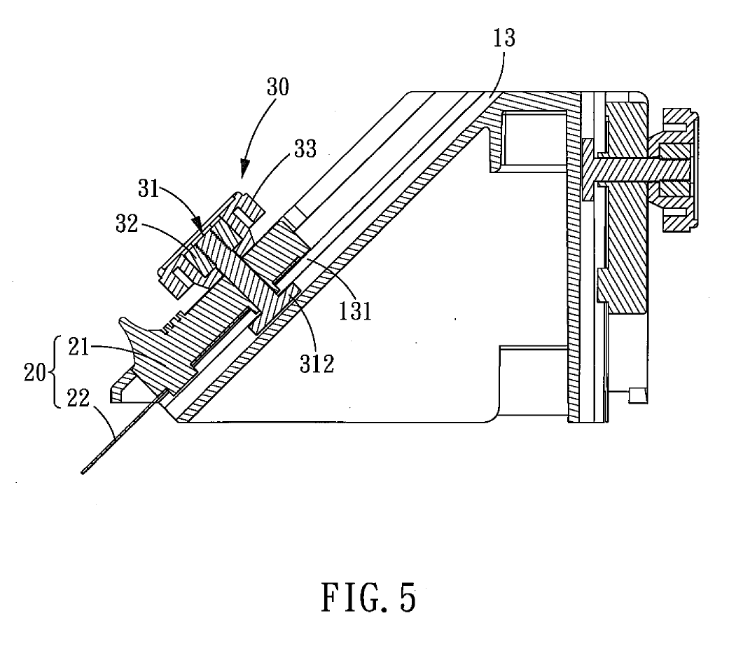

Referring to FIG. 4, to move the cutting assembly 20, the knob 33 and the nut 32 should be loosened initially, so as to increase the distance between the nut 32 and the flange 312 of the screw 31, such that the cutting assembly 20 and the screw 31 can slide in the first and the second restricting channels 12 and 13, respectively. When the cutting assembly 20 is adjusted to a suitable position as shown in FIG. 5, the knob 33 and the nut 32 are tightened to enable the distance between the nut 32 and the flange 312 of the screw 31 to be reduced, such that the cutting assembly 20 will be adjusted to press tightly against the main body 10 by the knob 33 and the restricting portion 131 of the second restricting channel 13, thus positioning the cutting assembly 20.

In this way, before cutting, the cardboard cutter can utilize the positioning assembly 30 to fix the cutting assembly 20 on the main body 10 stably so that the cutting problem caused by the excessive thickness or the hardness of the cardboard can be solved, it is apparent that the present invention has the advantages described as follows:

Firstly, since the cutting assembly 20 can be stably fixed on the main body 10 by the positioning assembly, the cutting assembly 20 will not be moved by the resistance of the cardboard during cutting process, and the cutting operation can be finished at one time. Thereby, the cutting process of the cardboard cutter of the present invention is simple.

Secondly, since the cardboard can be cut into a predetermined shape at one time, the cutting lines are quite trim and neat. Thereby, the products cut by the cardboard cutter of the present invention are beautiful.

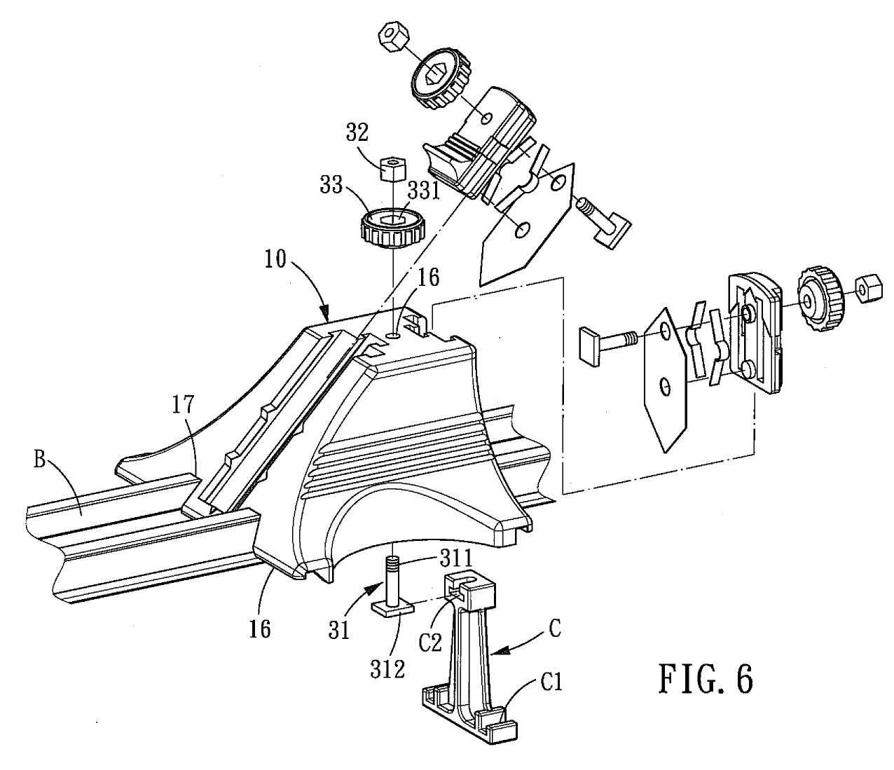

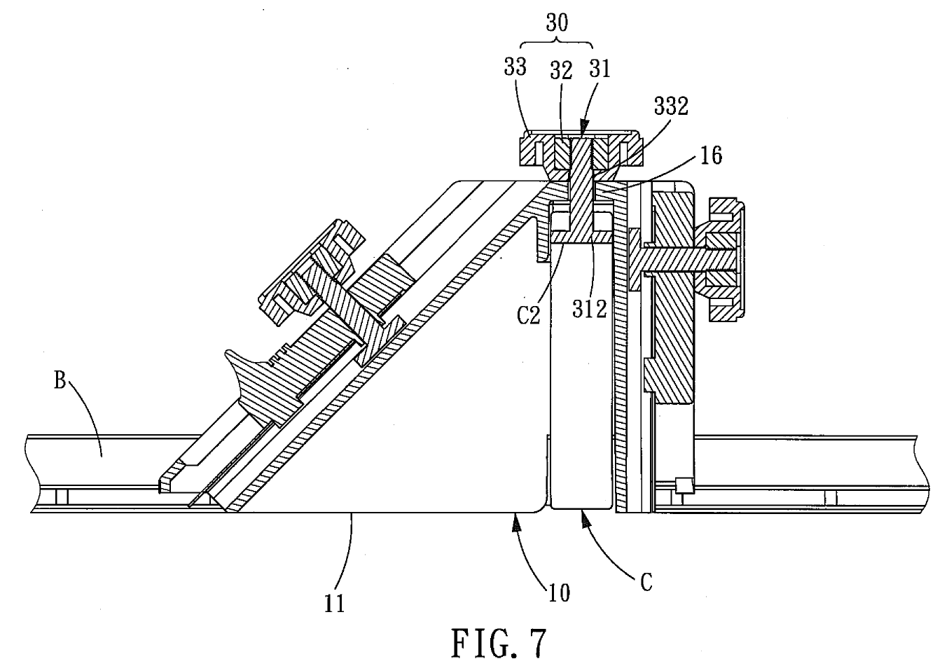

In addition, the main body 10 can further be defined with a through hole 16 in a surface opposite to the pressing surface 11 thereof as shown in FIGS. 6 and 7, and two parallel concave portions 17 are formed in the pressing surface 11 of the main body 10 for cooperating with two parallel tracks B so that the cardboard cutter can slide along the tracks B. Further, a fixing member C is disposed on the main body 10, one end of the fixing member C is formed with two cutting grooves C1 for cooperating with the tracks B, and the other end of the fixing member C is formed with a cavity C2. The cavity C2 is reverse T-shaped in cross section and includes a horizontal portion and a vertical portion, and the vertical portion of the cavity C2 is tapered inward. The fixing member C further includes a positioning assembly 30, the flange 312 of the screw 31 of the positioning assembly 30 is received in the cavity C2, and the threads 311 of the screw 31 are threaded with the nut 32 after passing through the through hole 16 of the main body 10 and the hole 332 of the knob 33, respectively.

By such arrangements, the knob 33 and the nut 32 are tightened to enable the distance between the nut 32 and the flange 312 of the screw 31 to be reduced, such that the cardboard cutter will be adjusted to press tightly against the tracks B by the knob 33 and the fixing member C, thus positioning the cardboard cutter.

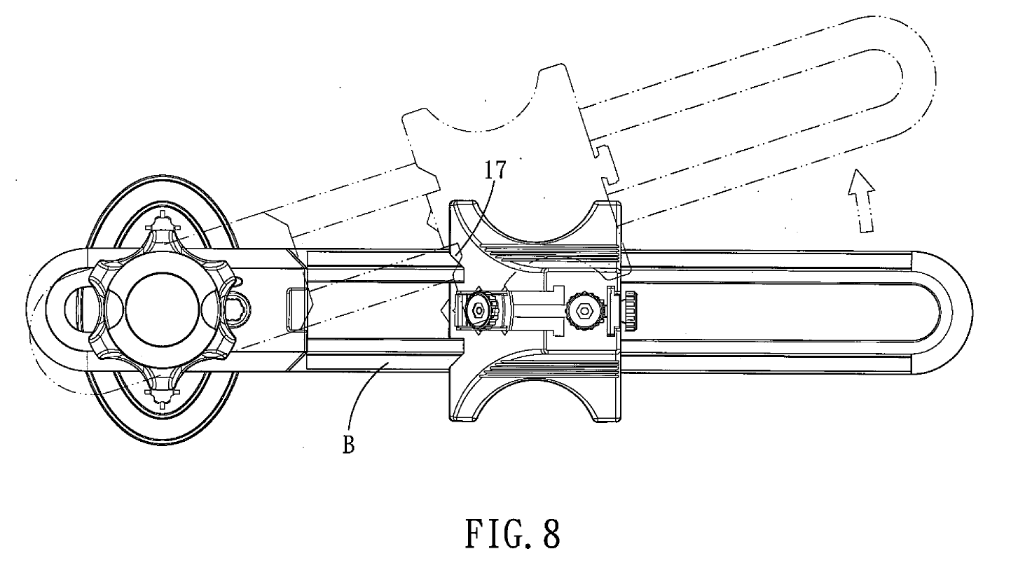

Referring to FIG. 8, with the concave portions 17, the cardboard cutter can be mounted on the parallel tracks B both ends of which are connected together to form a closed structure. When the tracks B rotate around one end of the closed structure, the cardboard cutter can cut in an arc-shaped fashion, thus producing various cutting shapes.

The angles of the cutting direction of the cutters 20 relative to the pressing surface 11 of the main body 10 in the above-mentioned embodiment are 45 degrees and 90 degrees, and other angles bigger than 0 degree are all applicable to the present invention.

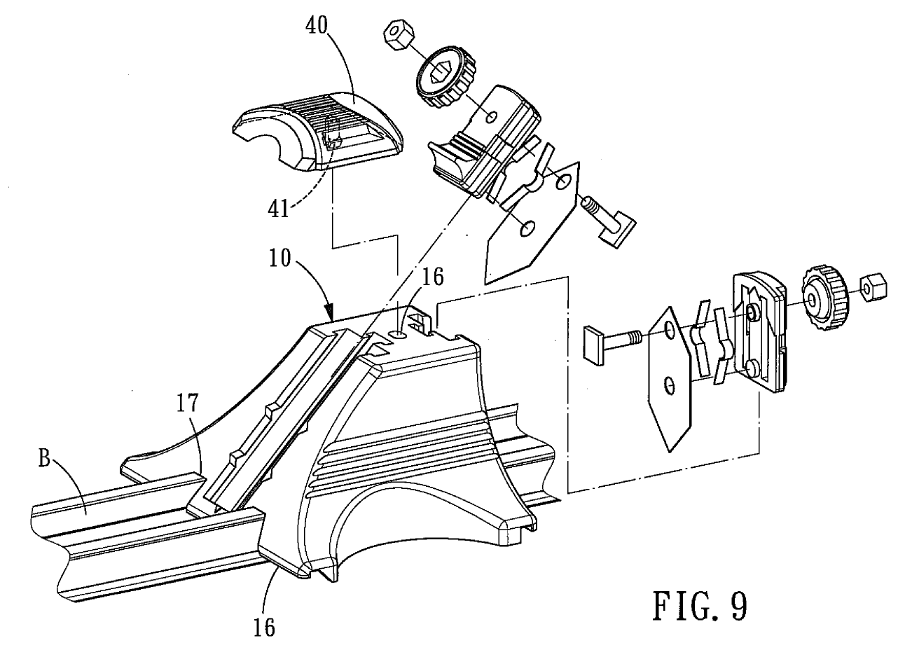

Further, referring to FIG. 9, when the main body 10 is used separately, a gripping member 40 having a combining post 41 can be disposed on the main body 10. The combining post 41 is passed through the through hole 16 of the main body 10, such that the gripping member 40 is assembled to the main body 10, thus facilitating the gripping.

While we have shown and described various embodiments in accordance with the present invention, it should be clear to those skilled in the art that further embodiments may be made without departing from the scope of the present invention.

What is claimed is:

1. A cardboard cutter, comprising:
a main body having a pressing surface for pressing against cardboard to be cut and being defined with two adjacent and connected restricting channels;
a positioning assembly including a screw and a nut, one end of the screw being disposed in one of the restricting channels of the main body, the other end of the screw being threaded with the nut; and
at least one cutting assembly having a blade and being slidably disposed in the other restricting channel of the main body, the screw of the positioning assembly being passed through the cutting assembly, a cutting direction of the blade being at a predetermined angle relative to the pressing surface of the main body, the cuffing assembly being fixed on the main body by the positioning assembly.

2. The cardboard cutter as claimed in claim 1, wherein the positioning assembly further includes a knob for insertion of the screw, and the knob is disposed between the nut and the cutting assembly and is defined with a containing recess for receiving the nut.

3. The cardboard cutter as claimed in claim 1, wherein the cutting direction of the cutting assembly lies at an angle of 45 degrees to the pressing surface of the main body.

4. The cardboard cutter as claimed in claim 1, wherein the cutting direction of the cutting assembly is vertical to the pressing surface of the main body.

5. The cardboard cutter as claimed in claim 1, wherein the cardboard cutter includes two cutting assemblies, the cutting direction of one of the cutting assemblies lies at an angle of 45 degrees to the pressing surface of the main body, and the cutting direction of the other cutting assembly is vertical to the pressing surface of the main body.

6. The cardboard cutter as claimed in claim 1, wherein two concave portions are formed in the pressing surface of the main body for cooperating with two parallel tracks so that the cardboard cutter can slide along the tracks.

7. The cardboard cutter as claimed in claim 6, wherein the main body is defined with a through hole in a surface opposite to the pressing surface thereof, a fixing member is disposed on the main body, one end of the fixing member cooperates with the tracks, and the other end of the fixing member is disposed with a positioning assembly, the positioning assembly cooperates with the through hole of the main body to fix the cardboard cutter in the tracks.

8. The cardboard cutter as claimed in claim 1, wherein the main body is defined with a through hole in a surface opposite to the pressing surface thereof and is disposed with a gripping member having a combining post, the combining post is passed through the through hole of the main body, such that the gripping member is assembled to the main body.
